(19) United States
(12) Patent Application Publication
(10) Pub. No.: US 2011/0204000 A1
(43) Pub. Date: Aug. 25, 2011

(54) METHOD FOR REMOVING SELENIUM FROM WATER

(75) Inventors: Larry Elbert Reed, Bartlesville, OK (US); Mark A. Hughes, Ponca City, OK (US); Bruce Bradley Randolph, Bartlesville, OK (US)

(73) Assignee: ConocoPhillips Company, Houston, TX (US)

(21) Appl. No.: 13/035,701

(22) Filed: Feb. 25, 2011

Related U.S. Application Data
(60) Provisional application No. 61/352,644, filed on Jun. 8, 2010.
(60) Provisional application No. 61/307,916, filed on Feb. 25, 2010.

(51) Int. Cl. B01D 21/00

(52) U.S. Cl. 210/721

(57) ABSTRACT

There is provided a method for removing selenium from an aqueous influent, comprising: adding a water-soluble reducing agent to an aqueous influent containing an oxidized selenium compound (Se^{x}, wherein x is the oxidation state and x>0); reducing said Se^{x} using said reducing agent at a temperature; removing said Se⁰ from said aqueous influent using a sorbent or a technique selected from the group consisting of filtration, coagulation, flocculation, clarification and centrifugation.

### CROSS-REFERENCE TO RELATED APPLICATIONS

This application is a non-provisional application which claims benefit under 35 USC §119(e) to U.S. Provisional Application Ser. No. 61/352,644 filed Jun. 8, 2010, entitled “SELENIUM REMOVAL METHODS AND SYSTEMS,” which is incorporated herein in its entirety and U.S. Provisional Application Ser. No. 61,307,916 filed Feb. 25, 2010, entitled “TREATMENT STAGES FOR SELENIUM REMOVAL,” which is incorporated herein in its entirety.

### STATEMENT REGARDING FEDERALLY SPONSORED RESEARCH OR DEVELOPMENT

None

### BACKGROUND OF THE INVENTION

The invention relates to water purification, in particular to removal of selenium from water.

Selenium salts are toxic in large amounts, but trace amounts of the element are necessary for cellular function in most, if not all, animals, forming the active center of the enzymes glutathione peroxidase and thioredoxin reductase (which indirectly reduce certain oxidized molecules in animals and some plants) and three known deiodinase enzymes (which convert one thyroid hormone to another). Selenium requirements in plants differ by species, with some plants, it seems, requiring none.

A major driver for refinery selenium regulation is selenium's effect on the reproductive toxicity of fish. For humans, although required in trace amounts, exceeding the Tolerable Upper Intake Level of 400 pm per day for selenium leads to selenosis, and as small as 5 mg (5000 μg) per day can be lethal. Symptoms of selenosis include garlic breath, gastrointestinal disorders, hair loss, sloughing of the nails, fatigue, irritability, neurological damage, and, in extreme cases, cirrhosis of the liver, pulmonary edema, and death. Elemental selenium (Se⁰) and most metallic selenides have relatively low toxicities because of their low bioavailability. By contrast, selenates (SeO₄²⁻) and selenites (SeO₃²⁻) are very toxic, having an oxidant mode of action similar to that of arsenic trioxide (AsO₃²⁻).

Selenium compounds are in petroleum, and a fraction of that selenium appears in wastewater after petroleum processing. Selenocyanate and selenite are the two species that can appear in refinery wastewater as a result of processing crude oil. Allowable concentration or discharge of selenium is very low. The current limits vary by location and permit. For example, at Rodeo Refinery, which discharges into San Pablo Bay, the limit is about 35 ppb; at the Carson refinery, which discharges into Publicly Owned Treatment Works (POTW), the limit is about 200 ppb; at Borger Refinery, which discharges into a small creek, it is about 5 ppb. Many areas have current discharge limits on selenium, and other areas are considering implementation of new, more stringent levels. Thus, in many areas, current limits on selenium discharge are too generous for future operations, and more selenium must be removed before disposing of selenium-bearing waste.

Methods for aqueous selenite removal to date include iron co-precipitation, reverse osmosis, nanofiltration, bioremediation, and constructed wetlands.

Iron co-precipitation relies on oxidation of selenocyanate to selenite, followed by precipitation of iron selenite. Ferrous ion (Fe²⁺) under basic conditions, preferably at a pH of about 9 can be used. See, for example, U.S. Pat. No. 4,405,464 and U.S. Pat. No. 4,806,264. However, sulfate ions in the water compete with the selenite in this reduction reaction, and the co-precipitiant does not effectively remove selenate. Furthermore, a problem with this technology is controlling the oxidation; that is, preventing oxidation of selenite to selenate. Since iron selenate is much more soluble than iron selenite, iron selenate is much more difficult to remove that is iron selenite.

Reverse osmosis is a filtration-type method. Unlike a typical filtration, insoluable components are removed form a fluid before treatment, then reverse osmosis is used to remove selected solutes. Sufficient pressure must be applied to a selective membrane to overcome the osmotic pressure of the system, allowing water to pass through the membrane and leaving the selenite (and other species) in the retained fraction. This selective filtration requires high pressure, the selenium species are never completely removed, and membrane fouling and dealing with the reject stream are major concerns when treating refinery waters. Only a portion of water passes through clean, and the rest of the water remains behind with the dissolved selenium species.

Like reverse osmosis, nanofiltration is a membrane filtration process used most often with water having low total dissolved solids. Nanofiltration can soften water by removing polyvalent cations, and be used in conjunction with reverse osmosis. But because nanofiltration is still a pressure filtration method, it has the same problems that reverse osmosis has, and will not reject selenocyante.

Bioremediation relies upon a microorganism, for example Rhizobium selenireducens or Pseudomonas seleniipraecipitatus, to reduce aqueous selenite to Se⁰. Because this method requires maintenance of living organisms, it is subsequently difficult to apply to large volumes of wastewater or to continuous treatment methods. Constructed wetlands provide an artificial environment for bioremediation, but also require a large land area to be effective.

U.S. Pat. No. 3,902,896 describes use of thiosulfate to aid metal deposition (cementation) in acidic solution onto a particulate base metal higher in the electromotive series than the deposited metal. When Cu is deposited onto a Ni base metal, selenium, a non-metal, can be also be removed. Selenite, however, is not reduced to Se⁰, and Se⁰ is not adsorbed. Also according to this patent, “cementation is, to a large extent, a surface phenomenon”, but solution-phase reduction of a selenium compound by thiosulfate does not involve a surface phenomenon.

U.S. Pat. No. 3,933,635 describes a method for removing selenite from acidic aqueous solution by reducing the selenite to Se⁰ with a metal, such as Zn, Fe, or Al, particularly at about 25° C. to 85° C. and at a pH of about 1 to 4. But U.S. Pat. No. 3,933,635 fails to teach or suggest a soluble reducing agent, such a thiosulfate, and use of a sorbent to remove Se⁰.

U.S. Pat. No. 4,935,146 and U.S. Pat. No. 5,200,082 describe removing aqueous selenite and selenate using an activated hydrotalcite sorbent, but fail to teach or suggest reducing selenite or selenate to Se⁰.

U.S. Pat. No. 5,510,040 describes removing aqueous selenite or selenate under acidic conditions (about pH 5) using a polydithiocarbamate and, optionally, an oxidizing agent. However, U.S. Pat. No. 5,510,040 fails to teach or suggest reducing an aqueous selenium species to Se⁰.

U.S. Pat. No. 7,413,664 describes a method for converting aqueous selenocyanate to selenite, followed by removal of selenite through co-precipitation with either Cu or Fe. However, the selenite is not further reduced to Se⁰ or adsorbed onto a sorbent.

U.S. Pat. No. 7,419,606 describes a method for removing a selenium compound, for example selenocyanate and/or selenite, by adsorption onto activated carbon or alumina in the presence of an activating agent, for example sulfite, SO₂, sulfurous acid, or combinations thereof. U.S. '606 refers to sulfur-impregnated substrates, not to virgin substrates, implying the need for sulfur impregantion. Further, the activiating agent is present to activate the sulfur on the substrate, not to affect the soluble selenium compound.

U.S. Pat. No. 7,413,664 describes a method for oxidizing selenocyanate to selenite by flowing a solution containing selenocyanate and dissolved oxygen through a bed of activated carbon.

Thus, what is needed in the art is an effective, simple and reliable means of removing selenium and its salts from waste effluents.

### SUMMARY OF THE INVENTION

The invention is generally directed to chemical methods of removing selenium and its salts from waste water that requires reduction of the various selenium salts to elemental selenium and removal of the elemental selenium. Removal can be by a variety of methods, including filtration, gravity based methods such as centrifugation or settling, or preferably, by sorption.

Selenite can be removed from wastewater by reaction with a reducing agent, for example thiosulfate (S₂O₃²⁻), forming elemental selenium which precipitates and can adsorb onto a sorbent, such as activated carbon. When combined with selenocyante removal, a stream containing both selenocyante and selenite can be treated to achieve an ultra-low selenium concentration outflow.

The thiosulfate/selenite reaction is enhanced by lowering the pH to about 2.5 and heating the inflowing material to about 70° C. (158° F.), either in batches or in continuous flow.

The process can operate as a stand alone process for removing selenite, or as an adjunct process in series following a complimentary process for selenocyante removal, so that both selenocyanate and selenite can be removed in the same process. For example, selenocyanate can be oxidized to selenite in the presence of dissolved oxygen and a bed of activated carbon.

This new method is relatively simple compared to current technologies for selenite removal, operates at a low cost, and is relatively easy to implement and integrate into existing wastewater treatment facilities.

Specifically, this application provides a method for removing selenium from an aqueous influent, comprising: adding a water-soluble reducing agent to an aqueous influent containing an oxidized selenium compound (Se^{x}, wherein x is the oxidation state and x>0); reducing said Se^{x} using said reducing agent at a temperature to Se⁰ having a particle size; removing said Se⁰ from said aqueous influent using a filtration or a sorbent or by gravity separation. The method can further comprise chemically coagulating or flocculating to increase Se⁰ particle size prior to removing said Se⁰. Increased particle size has the advantage of improving Se⁰ removal speed and efficiency. In some embodiments, removal of Se⁰ is effected by using a sorbent or a technique selected from the group consisting of filtration, coagulation, flocculation, clarification and centrifugation.

In some embodiments, the Se^{x} is selected from the group consisting of hyposelenite, selenite, perselenite, selenate, perselenate, and combinations thereof. In particular, the Se^{x} is selenite and x is 4.

The aqueous influent can further comprise selenocyante, and the method can further comprise removing the selenocyanate ions, for example, by dissolving oxygen in the aqueous influent, and passing the aqueous influent over activated carbon to oxidize selenocyanate to selenite.

The reducing agent can be selected from the group consisting of thiosulfate and sodium sulfite. In particular, the reducing agent comprises thiosulfate.

In some embodiments, Se⁰ is removed from said aqueous influent using a sorbent, and sorbent is selected from the group consisting of activated carbon, alumina, silica, silica-aluminas, zoelites and polymers. In particular, the sorbent comprises activated carbon.

The method can be a continuous flow method. In a particular embodiment, this application provides a method for removing selenium from an aqueous influent containing selenium ions, comprising: adjusting said aqueous influent to a pH of 2.5; reducing said selenium ions comprising selenite to Se⁰ using a water-soluble reducing agent comprising thiosulfate at a temperature of 70° C.; removing said Se⁰ by sorption to activated carbon. The selenium ions can further comprise selenocyante, and the method can further comprise removing said selenocyanate ions, for example, by dissolving oxygen in said aqueous influent; and passing said aqueous influent over activated carbon to oxidize selenocyanate to selenite.

### BRIEF DESCRIPTION OF THE DRAWINGS

FIG. 1. shows a selenite removal process, wherein selenite in an influent 100 is treated by acid injection 110 and reduced to Se⁰ with thiosulfate 120, and the Se⁰ is removed in sorbent bed 130.

FIG. 2. shows an adjunct selenocyanate-selenite removal process, wherein selenocyante is adsorbed in a first sorbent bed 260, and reduced selenite is adsorbed to a second sorbent bed 230 by injecting a thiosulfate solution 220.

FIG. 3. shows an adjunct selenocyanate-selenite removal process, wherein selenocyanate is oxidized to selenite via influent containing dissolved oxygen, and selenite is reduced to Se⁰. In these figures 110, 210, and 310 are all acid injection to reduce the pH; 140, 240, and 340, are (optional) for injection of base to neutralize the effluent.

### DESCRIPTION OF EMBODIMENTS OF THE INVENTION

The following abbreviations are used herein:

| | |
|---|---|
| Kₐ | Acid-dissociation constant |
| pH | negative log of proton concentration |
| pKₐ | Negative log of the acid-dissociation constant |
| Se⁰ | elemental selenium |

“Effluent” refers to an outflowing of liquid or gas from an a natural or manmade assemblage or structure, for example purified water flowing out of a wastewater treatment plant.

“Influent” refers to an inflowing of liquid or gas into a natural or manmade assemblage or structure, for example wastewater flowing into a wastewater treatment plant.

“Filtration” refers to mechanical or physical separation of solids from fluids (i.e., liquids or gases) by interposing a medium through which the fluid, and not the solid, can pass. Typically, solids are contaminated with some fluid, and filtrate contains fine particles of solid, depending on the pore size and filter thickness. In the case of reverse osmosis, the “filtration” typically rejects soluble species, as solids cause excessive membrane fouling.

A “surface filter” is a solid sieve which traps solid particles with or without the aid of filter paper, for example a Buchner funnel, belt filter, rotary vacuum-drum filter, crossflow filter, or screen filter. A “depth filter” refers to a bed of granular material which retains the solid particles as it passes, for example sand, silica gel (kieselguhr), cellulose, perilite or diatomaceous earth (celite). Filter media can be cleaned by rinsing with solvents or detergents, backwashing, or self-cleaning using point-of-suction backwashing without interrupting system flow. Fluids can filter by gravity, by vacuum on the filtrate (bottom) side of the filter (vacuum filtration), or by pressure added to the precipitate (top) side of the filter. Filtration by gravity is a form of gravity separation.

“Gravity separation” refers to separating two components from a suspension or homogeneous mixture by using gravity as the dominant force. Often other methods, such as flocculation, coagulation and vacuum filtration, are faster and more efficient than gravity separation, but gravity separation can be more cost effective. Examples of gravity separation include, but not limited to, preferential floating, clarification, thickening, and centrifugation. Heavy liquids such as tetrabromoethane can be used to separate ores from supporting rocks by preferential flotation. “Clarification” refers to separating fluid from solid particles, often used along with flocculation to make the unwanted solid particles sink faster to the bottom of a pool than the desired fluid. Thickening is clarification in reverse: Desired solids sink to the bottom and unwanted fluid to the surface.

Centrifugation is a process that involves use of centrifugal force to separate smixutres. Denser componsents of the mixture migrate away from the axis of the centrifuge, while less dense components migrate toward the axis. The rate of centrifugation is specified by the acceleration applied to the sample, typically measured in revolutions per minute (rpm) or gravitational force, also called g-force (g), which corresponds to about 9.8 m/s². Spinning is fast, for example at least 1000 rpm, such as at least 5000 rpm, at least 10000 rpm, at least 30000 rpm, or at least 70000 rpm.

“Sorption” refers to any action of absorption into or adsorption onto a solid material through chemical (chemisorption) and/or physical (physiorption) interactions. “Sorbent” refers to the solid material where sorption occurs. Examples of sorbents include, but are not limited to, carbon, charcoal, activated carbon, alumina, silica, silica-aluminas, zeolites and sorbent polymers.

“Zeolite” refers to microporous, aluminosilicate minerals. Common mineral zeolites include, but are not limited to, analcime, chabazite, clinoptilolite, heulandite, mordenite, natrolite, phillipsite, and stilbite. Artificial zeolites are more uniform and, thus, more commonly used in industrial applications. These zeolites receive a Zeolite Sieve of Molecular (ZSM) porosity number. For example, ZSM-5 is a zeolite of structure-type inverted mordenite framework, belonging to the pentasil family of zeolites.

“Oxidation number” refers to the charge an atom would have if its bound atoms and shared electrons were removed. An oxidized selenium species, denoted Se^{x}, contains a selenium atom with an oxidation number greater than zero. That is, the oxidized selenium compound comprises a selenium atom with a higher oxidation state than elemental selenium)(Se⁰). For example, selenite contains a selenium atom with an oxidation number of 4+ (x=4), and can be denoted as Se⁴⁺, Se^{IV}, or selenium(IV). Oxidation number is not to be confused with charge, which is determined on the basis of electron count and bound atoms. In the case of selenite (SeO₃²⁻), Se has a formal charge of +4 and each of the three oxygen atoms has a formal charge of −2, resulting in an overall charge of −2 for the selenite. By convention—and to help avoid confusion between oxidation number and charge—the sign (− or +) follows the digit in oxidation number, but precedes the digit in the charge.

“Reducing agent” refers to the element or compound in a reduction-oxidation (redox) reaction that donates an electron to another species, wherein the reducer, having lost an electron, is itself oxidized. The species receiving the electron is, thus, an “oxidizer”. Examples of reducing agents include, but are not limited to,
chemical elements, such as Li, Na, Mg, Zn, Fe, Al, and H₂;
alloys, such as sodium amalgam (Na—Hg), Ni—Mg, Ni—Al, Cu—Mg, and Cu—Al;
hydrides, such as sodium hydride (NaH), lithium hydride (LiH), calcium hydride (CaH), lithium aluminum hydride (LiAlH₄), diisobutylaluminum hydride (DIBAH), and sodium borohydride (NaBH₄);
mineral salts and mineral acids, such as sodium thiosulfate (Na₂S₂O₃), iron(II) sulfate (FeSO₄), sulfites, phosphites, hypophosphites, hypophosphous acid, nitrites, and nitrous acid; and
organic compounds, such as hydrazine (H₂NNH₂), oxalic acid (C₂H₂O₄), formic acid (HCOOH), ascorbic acid, dithiotreitol (Cleland's reagent), hydroquinone, and glyoxal.

The term “water-soluble reducing agent” refers to a reducing agent that can substantially and stably dissolve in water under reaction conditions. Metals, such as Zn, Fe and Al, and alloys, such as Ni—Mg, Ni—Al, Cu—Mg, and Cu—Al, do not dissolve in water, even when presented as finely divided powder. Mineral salts are soluble reducing agents and, thus, are particularly suited for use in this invention, in particular mineral salts which provide a thiosulfate ion, such as sodium thiosulfate. Many organic compounds, such as organic acids, are water-soluble and are also considered soluble reducing agents.

Thiosulfate (S₂O₃²⁻) is an oxyanion of sulfur and can be produced by the reaction of sulfite (SO₃²⁻) with elemental sulfur(S⁰) in boiling water, and can occur naturally in hot springs or geysers. Under acidic conditions of about pH 1, the dominant ion in aqueous solution is hydrogen thiosulfate (HS₂O₃⁻, pKₐ=1.01). Under more acidic conditions (about pH 0), thiosulfuric acid (H₂S₂O₃, pKₐ=0.35) is the main species in aqueous solution.

“Selenium” refers to the non-metallic chemical element with atomic number 34. Selenium is a chalcogen—that is, a member of the oxygen family—along with the elements oxygen, sulfur, tellurium, and polonium. Selenium can occur in organic compounds, for example dimethyl selenide ((CH₃)₂Se), selenomethionine, selenocysteine, methylselenocysteine, selenopurine, selenoinsine, selenoguanosine, and selenourea, all of which have high bioavailability and are toxic in large doses. Selenium can also be found in water in ionic form, for example as an ion shown in Table 1.

TABLE 1
Selenium Ions

| | | Se Oxidation | # of | First protonation | Second |
|---|---|---|---|---|---|
| Ion | Structure | # (x) | Oxygens | (name) | protonation (name) |
| selenide | Se²⁻ | 2− | 0 | HSe⁻ | H₂Se |
| | | | | (hydrogen selenide ion) | (hydrogen selenide) |
| hyposelenite | SeO₂⁻ | 3+ | 2 | HSeO₂⁻ | H₂SeO₂ |
| | | | | (hydrogen hyposelenite) | (hyposelenous acid) |
| selenite | SeO₃²⁻ | 4+ | 3 | HSeO₃⁻ | H₂SeO₃ |
| | | | | (hydrogen selenite) | (selenous acid) |
| selenate | SeO₄²⁻ | 6+ | 4 | HSeO₄⁻ | H₂SeO₄ |
| | | | | (hydrogen selenate) | (selenic acid) |
| perselenite | SeO₂(OO)²⁻ | 6+ | 4 | SeO₂(OOH)⁻ | SeO(OH)(OOH) |
| | | | | (hydrogen perselenite) | (perselenous acid) |
| perselenate | SeO₅²⁻ | 8+ | 5 | HSeO₅⁻ | H₂SeO₅ |
| | | | | (hydrogen perselenate) | (perselenic acid) |
| seleno- | SeCN⁻ | 0 | 0 | — | HSeCN |
| cyanate | | | | | (hydrogen |
| | | | | | selenocyanate) |

“Selenite” refers to an anion with the formula SeO₃²⁻. Under neutral conditions (pH 7), the dominant ion in aqueous solution is hydrogen selenite (HSeO₃⁻, pK_{A}=7.3). Under acidic conditions (about pH 2), fully protonated selenous acid (H₂SeO₃, pK_{A}=2.46) is the main species in aqueous solution.

“Selenate” refers to an anion with the formula SeO₄²⁻. Selenate is analogous to sulfate and is highly soluble in aqueous solution at ambient temperature. Unlike sulfate, selenate is a somewhat good oxidizer and can be reduced to selenite or selenium. Selenate is more acidic than selenite. Under acidic conditions (pH 2), hydrogen selenate (HSeO₄⁻, pKₐ²=1.92) is the main ion in aqueous solution. Very strongly acidic conditions (pH −7) are necessary to produce selenic acid (H₂SeO₄, pKa¹=−7) as the main species.

“Selenocyante” refers to an anion with the formula SeCN. Selenocyante can be removed from aqueous waste by co-precipitation with a cupric salt in the presence of a reducing agent, for example thiosulfate. The reducing agent reduces the cupric salt to a cuprous salt, but does not reduce selenocyanate, with which the reducing agent does not react. See, for example, U.S. Pat. No. 6,214,238.

“Sorbent” refers to a material that can absorb or adsorb a chemical from the surrounding environment through chemisorption, physisorption, or some other mechanism. Examples of sorbents include, but are not limited to, activated carbon and alumina.

According to the present invention and without wishing to be bound by any theory, aqueous selenite is reduced with thiosulfate to solid elemental selenium, as depicted in the following equation:

SeO₃²⁻_{(aq)}+S₂O₃²⁻_{(aq)}→Se⁰₍ₛ₎+2SO₃²⁻_{(aq)} (Equation 5)

The Se⁰ can have a small enough particle size to be disperse as a colloid or suspension. In some embodiments, the selenite is reduced under acidic conditions, particularly at a temperature above normal, for example about 70° C. Under hot acidic conditions, thiosulfate decomposes to sulfur dioxide (SO₂) and elemental sulfur (S⁰) (Equation 6). The sulfur dioxide, dissolved in water, forms sulfous acid, which equillabrates to sulfide ion, which is protonated under these conditions (Equation 7). The sulfite then reduces selenite to Se⁰ (Formula 8):

S₂O₃²⁻_{(aq)}+2H⁺→SO₂+H₂O+S⁰(s) (Equation 6)

SO₂+H₂O⇄H₂SO₃⇄HSO₃⁻+H⁺ (Equation 7)

H₂SeO_{3(aq)}+2HSO₃⁻_{(aq)}→Se⁰₍ₛ₎+2HSO₄⁻_{(aq)}+H₂O (Equation 8)

The present invention is exemplified with respect to aqueous selenite removal. However, this method is exemplary only, and the invention can be broadly applied to removal of any aqueous selenium-containing species. The following examples are intended to be illustrative only, and not unduly limit the scope of the appended claims.

### EXAMPLE 1

### Removal of Selenite from Aqueous Influent

Oxidized selenium compounds, such as selenite, are very poisonous and must be removed from wastewater. This example, and those that follow, provide simple, effective, continuous flow method to remove selenite from wastewater, producing purified water with very low concentrations of selenium compounds.

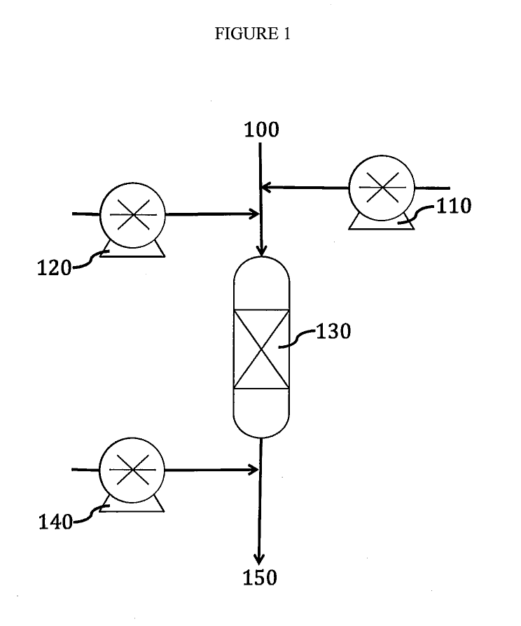

Referring to FIG. 1, aqueous influent 100 containing selenite is reacted with acid 110, for example sulfuric acid, to reduce the pH to about 2.5. The influent is also warmed to about 158° F. (70° C.). Then, thiosulfate solution 120 is injected to reduce the selenite to Se⁰. The Se⁰ is sorbed in sorbent bed 130 comprising activated carbon. The Se⁰ is adsorbed or absorbed whether precipitated, suspended or dissolved. Base 140 is injected into the aqueous influent, producing a neutralized effluent 150 with a low content of selenium species.

### EXAMPLE 2

### 1-Bed Selenoyanate-Selenite Removal

In addition to selenite, selenocyante is also a selenium ion common to wastewater. Selenocyanate can be oxidized to selenite, and the selenite reduced to Se⁰, and sorbed from solution.

Referring to FIG. 1, an aqueous influent 100 containing selenite and selenocyante is sparged with oxygen, reacted with acid 110 to reduce the pH to about 2.5, warmed to about 158° F. (70° C.). Thiosulfate solution 120 is injected into the influent to reduce the selenite to Se⁰. The influent flows through sorbent bed 130 comprising activated carbon. On the sorbent bed, selenocyanate is oxidized to selenite, which in turn is reduced to Se⁰ by excess thiosulfate in solution. Finally, Se⁰, generated from the selenocyanate and from the original selenite, is adsorbed in the sorbent bed 130. At the end, base 140 is injected into the aqueous influent, producing a neutralized effluent 150 with a low content of selenium species. The influent can be sparged with oxygen so as to prevent conversion of selenite to selenate.

### EXAMPLE 3

### 2-Bed Removal of Selenocyanate/Selenite

To remove both selenocyanate and selenite from the same influent, two sorbent beds can be used, one specific to selenocyanate adsorption, and a second for adsorption of Se⁰ produced from selenite reduction.

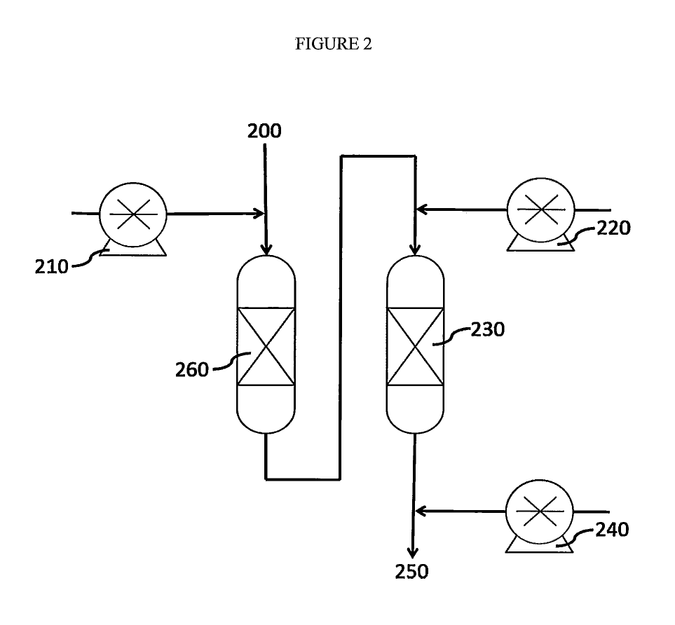

Referring to FIG. 2, an influent water stream 200 containing selenite and selenocyanate is reacted with acid 210 to reduce pH and warmed to about 158° F. (70° C.). The influent is passed through a first sorbent bed 260 to remove selenocyanate. Thiosulfate 220 is injected into the influent of the second bed to reduce selenite to Se⁰. The Se⁰ is adsorbed to a second sorbent bed 230 comprising activated carbon. Base 240 is injected into the influent, producing neutralized effluent 250 with low selenium compound content.

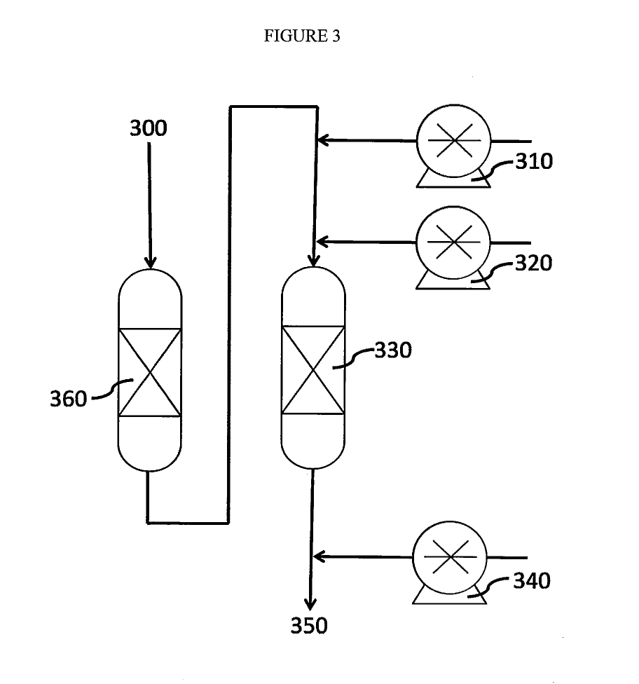

In an alternative arrangement, referring to FIG. 3, the aqueous influent 300 is sparged with oxygen, and passed through a first bed 360 comprising activated carbon. Here, the selenocyanate is oxidized to selenite. Then, the influent is sequentially injected with acid 310 to adjust the pH to about 2.5 and with thiosulfate solution 320 to reduce the selenite to Se⁰. The Se⁰ is removed from the influent in a second bed 330 comprising activated carbon. At the end, base 240 is injected into the influent, producing neutralized effluent 250 with low selenium compound content.

The following references are incorporated by reference in their entirety:
U.S. Pat. No. 3,902,896.
U.S. Pat. No. 3,933,635.
U.S. Pat. No. 4,405,464.
U.S. Pat. No. 4,806,264.
U.S. Pat. No. 4,935,146.
U.S. Pat. No. 5,200,082.
U.S. Pat. No. 4,940,549.
U.S. Pat. No. 5,089,141.
U.S. Pat. No. 5,510,040.
U.S. Pat. No. 6,214,238.
U.S. Pat. No. 7,413,664.
U.S. Pat. No. 7,419,606.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

What is claimed is:

1. A method for removing selenium from an aqueous influent, comprising:
a. adding a water-soluble reducing agent to an aqueous influent containing an oxidized selenium compound (Se^{x}, wherein x is the oxidation state and x>0);
b. reducing said Se^{x} using said reducing agent at a temperature;
c. removing said Se⁰ from said aqueous influent using a sorbent or a technique selected from the group consisting of filtration, coagulation, flocculation, clarification and centrifugation.

2. The method of claim 1, wherein said Se^{x} is selected from the group consisting of hyposelenite, selenite, perselenite, selenate, perselenate, and combinations thereof.

3. The method of claim 2, wherein said Se^{x} is selenite.

4. The method of claim 1, wherein x is 4.

5. The method of claim 3, wherein said aqueous influent further comprises selenocyanate.

6. The method of claim 4, further comprising removing said selenocyanate ions.

7. The method of claim 4, further comprising:
a. dissolving oxygen in said aqueous influent; and
b. passing said aqueous influent over activated carbon to oxidize selenocyanate to selenite.

8. The method of claim 1, wherein said reducing agent is selected from the group consisting of thiosulfate and sodium sulfite.

9. The method of claim 8, wherein said water-soluble reducing agent comprises thiosulfate.

10. The method of claim 1, wherein said Se⁰ is removed from said aqueous influent using a sorbent, wherein said sorbent is selected from the group consisting of activated carbon, alumina, silica, silica-alumina, and polymers.

11. The method of claim 10, wherein said sorbent comprises activated carbon.

12. The method of claim 1, wherein said temperature is 70° C.

13. The method of claim 1, further comprising adjusting said aqueous influent to a pH of less than 7.

14. The method of claim 13, wherein said pH is about 2.5.

15. The method of claim 1, wherein said method is a continuous flow method.

16. A method for removing selenium from an aqueous influent containing selenium ions, comprising:
a. adjusting said aqueous influent to a pH of 2.5;
b. reducing said selenium ions comprising selenite to Se⁰ using a water-soluble reducing agent comprising thiosulfate at a temperature of 70° C.;
c. removing said Se⁰ by sorption to activated carbon.

17. The method of claim 16, wherein said selenium ions further comprise selenocyanate.

18. The method of claim 17, further comprising removing said selenocyanate ions.

19. The method claim 17, further comprising:
a. dissolving oxygen in said aqueous influent; and
b. passing said aqueous influent over activated carbon to oxidize selenocyanate to selenite.

20. The method of claim 19, wherein said method is a continuous flow method.
